(19) United States
(12) Patent Application Publication
(10) Pub. No.: US 2006/0284403 A1
(43) Pub. Date: Dec. 21, 2006

(54) Inflatable vehicle occupant protection device construction

(75) Inventor: Bruce R. Hill, Bloomfield Hills, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/157,523

(22) Filed: Jun. 21, 2005

(51) Int. Cl. B60R 21/235

(52) U.S. Cl. 280/743.1

(57) ABSTRACT

An inflatable vehicle occupant protection device (14) includes overlying woven panels (40, 42, 90) having portions interconnected to define an inflatable volume (50, 94). A coating (190, 208) applied to at least one surface of each panel (40, 42, 90) to control the gas permeability of the panels. The panels (40, 42, 90) each have at least one portion (174, 200) woven in a plain weave pattern and at least one portion (176, 202, 204) woven in a non-plain weave pattern in which fill yarns are woven around single warp yarns in an alternating fashion.

### FIELD OF THE INVENTION

The present invention relates to an inflatable vehicle occupant protection device for helping to protect an occupant of a vehicle.

### BACKGROUND OF THE INVENTION

It is known to inflate an inflatable vehicle occupant protection device to help protect a vehicle occupant in the event of a vehicle collision. Examples of inflatable vehicle occupant protection devices include driver and passenger side air bags, side air bags, inflatable curtains, inflatable seat belts, inflatable knee bolsters, and inflatable head liners.

Inflatable vehicle occupant protection devices may have a variety of constructions. For example, an inflatable vehicle occupant protection device may be constructed of overlying woven panels that are interconnected by means, such as stitching or ultrasonic welding, to form connections or seams that help define an inflatable volume of the protection device. As another example, an inflatable vehicle occupant protection device may have a one piece woven construction in which overlying panels are woven simultaneously. The panels are woven together to form connections or seams that help define an inflatable volume of the one piece woven protection device.

### SUMMARY OF THE INVENTION

The present invention relates to an inflatable vehicle occupant protection device that includes overlying woven panels having portions interconnected to define an inflatable volume. A coating is applied to at least one surface of each panel to control the gas permeability of the panels. The panels each have at least one portion woven in a plain weave pattern and at least one portion woven in a non-plain weave pattern in which fill yarns are woven around single warp yarns in an alternating fashion.

The present invention also relates to an inflatable vehicle occupant protection device that includes overlying woven panels having portions interconnected to define an inflatable volume. The woven panels are woven with at least two different weave patterns. The weave patterns are configured to provide substantially uniform shrinkage in a fill direction of the panels along substantially the entire length of said panels measured perpendicular to the fill direction. The weave patterns also are configured to make the panels readily foldable to facilitate formation of a small package size of the inflatable vehicle occupant protection device.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect an occupant of a vehicle, according to the present invention;

FIG. 2 is a plan view illustrating the manufacture of a portion of the apparatus of FIG. 1, according to a first embodiment of the present invention;

FIG. 3A is a weave diagram for a portion of the apparatus of FIG. 2;

FIG. 3B is a sectional view illustrating the weave of a portion of the apparatus of FIG. 2 taken generally along line 3B-3B in FIG. 3A;

FIG. 4 is a weave diagram for another portion of the apparatus of FIG. 2;

FIG. 5 is a plan view illustrating another portion of the apparatus of FIG. 1;

FIG. 6 is a plan view illustrating the manufacture of a portion of the apparatus of FIG. 1, according to a second embodiment of the present invention; and

FIGS. 7A and 7B are sectional views of yarns that may be used to construct the apparatus of FIG. 1, according to a third embodiment of the present invention.

### DETAILED DESCRIPTION OF THE INVENTION

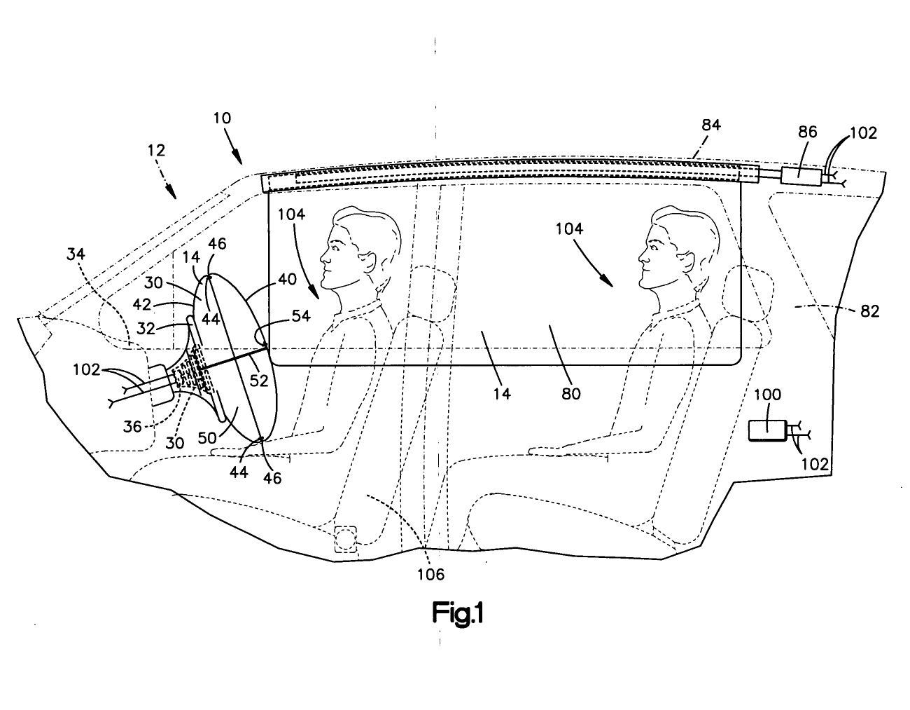

An apparatus 10 helps to protect an occupant of a vehicle 12. The apparatus 10 includes inflatable vehicle occupant protection devices 14 that are inflatable to help protect occupants 104 of the vehicle 12. Referring to FIG. 1, the inflatable vehicle occupant protection devices 14 may include a air bag 30 and an inflatable curtain 80. In the embodiment illustrated in FIG. 1, the protection devices 14 are shown on a driver side 20 of the vehicle 12. The vehicle 12 may include similar or identical protection devices 14 on a passenger side (not shown) of the vehicle. Other vehicle occupant protection devices (not shown) that may be constructed in accordance with the invention may include; for example, side impact air bags, inflatable seat belts, inflatable knee bolsters, and inflatable head liners.

In the embodiment illustrated in FIG. 1, the air bag 30 is mounted to a steering wheel 32 of the vehicle 12. The air bag 30 could, however, be mounted in an alternative location. For example, a passenger side air bag (not shown) may be mounted in a dash or instrument panel 34 of the vehicle 12. An inflator 36 is connected in fluid communication with the air bag 30. The air bag 30 is inflatable from a deflated and stored condition illustrated in dashed lines at 30′ in FIG. 1 to the inflated and deployed condition illustrated in solid lines at 30 in FIG. 1.

The air bag 30 includes front and rear panels 40 and 42, respectively, that are arranged in an overlying manner and interconnected by means 44, such as stitching. The stitching 44 extends through the panels 40 and 42 adjacent a periphery of the panels, thus forming a connection or seam 46 that helps define an inflatable volume 50 of the air bag 30. As shown in the embodiment of FIG. 1, the air bag 30 may include a tether 52 for helping to limit movement of the front panel 40 away from the rear panel 42 and the steering wheel 32 when the air bag is deployed. One end of the tether 52 is connected to the front panel 40 by stitching 54 that extends through the front panel and the tether. An opposite end of the tether may be connected to the rear panel 42 or to vehicle structure, such as the steering wheel 32.

In the embodiment illustrated in FIG. 1, the inflatable curtain 80 is mounted adjacent a side structure 82 of the vehicle 12 and a roof 84 of the vehicle. An inflator 86 is connected in fluid communication with the inflatable curtain 14 through a fill tube 88. The fill tube 88 includes openings (not shown) through which inflation fluid is directed into inflatable curtain 80. The fill tube 88 may be constructed of any suitable material, such as plastic, metal or fabric. Alternatively, the fill tube 88 may be omitted, in which case the inflator 86 may be connected directly to the inflatable curtain 80. The inflatable curtain 80 is inflatable from a deflated and stored condition illustrated in dashed lines at 80′ in FIG. 1 to the inflated and deployed condition illustrated in solid lines at 80 in FIG. 1.

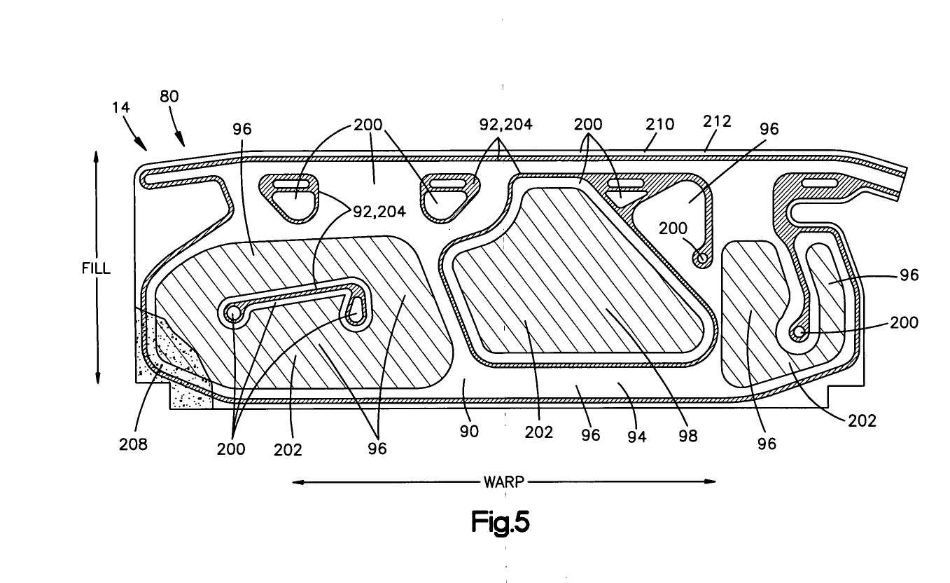

Referring to FIG. 5, the inflatable curtain 80 includes panels 90 that are arranged in an overlying manner and interconnected to form connections or seams 92 that help define an inflatable volume 94 of the inflatable curtain 80. The seams 92 may also help define inflatable chambers 96 within the inflatable volume 94 and non-inflatable portions 98 of the inflatable curtain 80. The inflatable curtain 80 may have a one piece woven construction in which the panels 90 of the curtain are woven simultaneously as separate single layers of material. At the seams 92, where the panels 90 are interconnected, the panels are woven together in a single layer.

The inflators 36 and 86 may have a known construction that is suitable for inflating their respective protection devices 14. For example, the inflators 36 and 86 may contain a stored quantity of pressurized inflation fluid (not shown) in the form of a gas for inflating their respective protection devices 14. The inflators 36 and 86 alternatively could contain a combination of pressurized inflation fluid and ignitable material for heating the inflation fluid, or could be a pyrotechnic inflator that uses the combustion of gas-generating material to generate inflation fluid. As a further alternative, the inflators 36 and 86 could be of any suitable type or construction for supplying a medium for inflating their respective protection devices 14.

The vehicle 12 includes one or more sensors (shown schematically at 100 in FIG. 1) for sensing the occurrence of an event for which inflation of any or all of the protection devices 14 is desired. Examples of such events include a vehicle impact (e.g., front, rear, side, offset, or angled impacts), a vehicle rollover, or both. Upon sensing the event, the sensor 100 provides electrical signal(s) over lead wires 102 to the appropriate inflators 36 and 86, which cause the inflators to be actuated in a known manner and discharge fluid under pressure into their respective protection devices 14.

The protection devices 14 inflate under the pressure of the inflation fluid from the inflators 36 and 86. The air bag 30 inflates from the deflated and stored position in the steering wheel 32 to the deployed position between the steering wheel and an occupant 104 of the front vehicle seat 106. The inflatable curtain 80 inflates away from the roof 84 to a position between the side structure 82 of the vehicle 12 and any occupants 104 of the vehicle.

The protection devices 14, when inflated, help protect a vehicle occupant in the event of an impact to the vehicle 12, a vehicle rollover, or both. The protection devices 14, when inflated, help absorb the energy of impacts with the protection device and help to distribute the impact energy over a large area of the protection device.

For a sewn construction of an inflatable vehicle occupant protection device 14, such as the air bag 30, multiple front panels 40, rear panels 42, or both front and rear panels may be woven in a single roll of fabric material. The front and rear panels 40 and 42 may then be cut out, positioned in an overlying relationship, and interconnected by means, such as stitching the panels together. This is the case with the sewn construction of the air bag 30 described above. An example in which multiple front and rear panels 40 and 42 are woven in a single roll is shown in FIG. 2.

Referring to FIG. 2, multiple woven panels 152 are formed in a continuous roll of fabric material, a portion 150 of which is shown in FIG. 2. The roll 150 has a length measured in a warp direction of the roll and a width measured perpendicular to the length and in a fill direction of the roll. The portion of the roll 150 shown in FIG. 2 includes eight (8) panels 152. The panels 152 are delineated by imaginary cut lines 154 indicated in dashed lines in FIG. 2.

The panels 152, when cut from the roll 150 of FIG. 2, form the front and rear panels 40 and 42 that are interconnected to form the front impact air bag 30 of FIG. 1. A first row 160 of panels 152 form the front panels 40 of the air bag 30. A second row 162 of panels 152 form rear panels 44 of the air bag 30. As shown in FIG. 2, the rear panels 42 may include openings 164 for venting inflation fluid from the air bag 30. The openings 164 are delineated by imaginary cut lines indicated in dashed lines in FIG. 2.

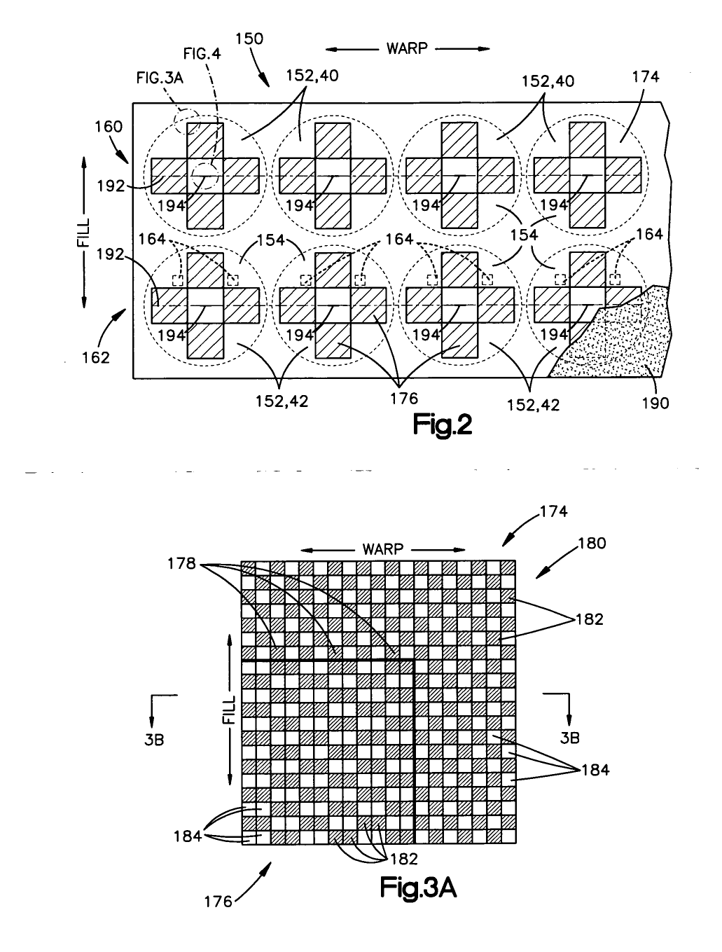

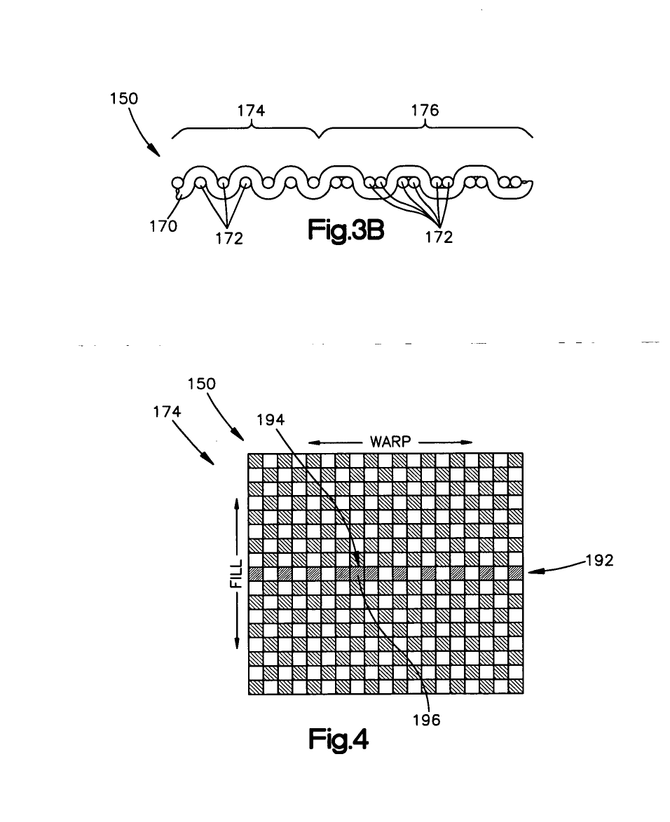

FIGS. 3A-3C illustrate a portion of the woven roll 150 of FIG. 2. Referring to FIGS. 3B and 3C, the woven roll 150 includes a plurality of warp yarns, or ends, indicated at 170. Also, the woven roll 150 includes a plurality of fill yarns, also known as weft yarns, or picks, indicated at 172. The warp yarns 170 and the fill yarns 172 are oriented perpendicular to each other. The warp yarns 170 and fill yarns 172 are thus woven around each other in an alternating “up and down” fashion. Depending on the particular weave pattern, the one or more fill yarns 172 are woven alternately over and under one or more warp yarns 170.

FIG. 3A illustrates a weave diagram 180 for a portion of the woven roll 150. In the weave diagram 180 of FIG. 3A, each block in the diagram is representative of an intersection between a warp yarn and a fill yarn of the roll 150. The shading of the blocks indicates the position of the warp yarn at the respective intersections represented by the blocks. The shaded blocks indicated at 182 in the weave diagram 180 indicate the warp yarn being “up” or passing over the corresponding fill yarn as viewed looking down on the roll 150 as shown in FIG. 2. The non-shaded blocks indicated at 184 in the weave diagram 180 indicate the warp yarn being “down” or passing under the corresponding fill yarn as viewed looking down on the roll 150 as viewed in FIG. 2.

The portion of the woven roll 150 illustrated in FIGS. 3A-3C includes portions woven in a one-by-one (1×1) weave pattern referred to in the art as a “plain weave” pattern. In this plain weave pattern of the woven roll 150, each warp yarn 170 is woven around each fill yarn 172 in an alternating fashion. Also, in the plain weave pattern, each fill yarn 172 is woven around each warp yarn 170 in an alternating fashion. Portions of the roll 150 woven with a plain weave pattern are indicated generally at 174 in FIGS. 3A-3C.

The portion of the roll 150 illustrated in FIGS. 3A-3C also includes portions woven in a non-plain woven weave pattern. These portions are indicated generally at 176 in FIGS. 3A-3C. In FIG. 3A, the plain woven portion 174 and non-plain woven portion 176 are delineated by the darkened line. In the embodiment illustrated in FIGS. 3A-3C, the non-plain woven portions 176 are woven in a one-by-two (1×2) weave pattern. The non-plain woven portions 176 could have an alternative non-plain weave pattern, which is described below.

In the warp direction of the 1×2 weave pattern of the non-plain woven portion 176, each warp yarn 170 is woven around groups of two fill yarns 172 in an alternating fashion. This is best shown in FIGS. 3A and 3B. A “float”, as known in the art, is a portion of a weave pattern in which a warp yarn 170 or a fill yarn 172 extends over or under two or more adjacent fill or warp yarns.

According to the present invention, the protection devices 14 have woven constructions that promote seam integrity, facilitate processing the protection devices, and allow for easier and more compact packaging of the protection devices in the deflated and stored position. This is achieved by tailoring the weave patterns in selected areas or regions of the protection devices 14.

To promote seam integrity in the sewn construction of the air bags 30, the stitching 44 that connects the front and rear panels 40 and 42 extends through the plain woven portions 174 of the panels. Also, any stitching 54 connecting a tether 52 to the front panel 40 or rear panel 42 extends through plain woven portions 174 of the panels.

Referring to FIG. 2, the non-plain woven portions 176 of the woven roll 150 and the front and rear panels 40 and 42 are cross hatched. The plain woven portions 174 of the woven roll and the front and rear panels 40 and 42 are not cross hatched. As shown in FIG. 2, the plain woven portions 174 of the front and rear panels 40 and 42 extend around the entire periphery of the panels along this periphery. The stitching 46 (see FIG. 1) that interconnects the panels 40 and 42 to form the seams 48 extends only through plain woven portions 174 of the panels. If the air bag 30 includes a tether 52, as shown in FIG. 1, the tether is stitched to the plain woven portions 174 in the center of the panels 40 and 42.

In the plain woven portions 174, the warp yarns 170 and fill yarns 172 are woven around each other at every intersection of the yarns. For a given weave density of a woven fabric (i.e., for a given number of yarns per unit length), a plain woven portion of the fabric will have a weave that, in comparison with non-plain woven portions, is tight and resistant to yarn shifting. This tightly woven and resistant to yarn shifting construction provides the plain woven portions 174 of the panels 40 and 42 with better edge combing properties in comparison with non-plain woven portions 176 of the panels.

“Edge combing” refers to the tendency of the warp and fill yarns of a woven material to unravel or become un-woven at or near an edge of the fabric. The warp and fill yarns of plain woven materials, being woven around each other at every possible intersection of the yarns, tend to interlock with each other more tightly than non-plain woven materials and thus exhibit better edge combing properties than non-plain woven materials. These better edge combing properties help provide an improved seam integrity for a stitched seam because the yarns adjacent the stitching have a higher resistance to unraveling or becoming un-woven, which could cause the seam to fail.

Plain woven materials, having warp and fill yarns that are woven around each other at every possible intersection of the yarns and having the resulting tight weave with high resistance to yarn shifting, will exhibit a stiffness that is higher than that of the non-plain woven materials. Because of this stiffness, plain woven materials exhibit a relatively high resistance to rolling and folding in comparison with non-plain woven materials.

The inclusion of the non-plain woven portions 176 of the panels 40 and 42 helps reduce the overall stiffness of the air bag 30, which helps improve the packaging properties of the air bag. These improved packaging properties of the air bag 30 include improvements in the ease with which the air bag 30 can be rolled, folded, or otherwise placed in the deflated and stored condition. These improved packaging properties help reduce the space required for storing the air bag 30 in the deflated condition. Thus, the plain woven 174 and non-plain woven 176 portions of the panels 40 and 42 are configured to help provide high seam integrity along with improved packaging properties.

The plain woven and non-plain woven portions 174 and 176 of the panels 40 and 42 may have different permeabilities. For example, the non-plain woven portions 176 may have a higher permeability than the plain woven portions 174 due to the looser weave and higher propensity for yarn shifting in the non-plain weave. According to the present invention, a coating 190 (FIG. 2) is applied to the panels 40 and 42 to help control the gas permeability of the panels and maintain the gas permeability of the panels at a desired level. The air bag 30 may thus maintain the improved seam integrity and packaging provided by the plain an non-plain woven portions described above without sacrificing permeability.

The coating 190 may be any coating suited to provide desired permeability characteristics. For example, the coating 190 may comprise a gas impermeable or substantially gas impermeable urethane or silicone material. One such material is a polycarbonate polyurethane coating. To help prevent blocking, a polyether or polyester based urethane coating may be applied as an additional coating or may be mixed with the polycarbonate polyurethane. A liquid based flame retardant, such as Fyroflex RDP or Lindol CDP, may also be added to the coating. The total weight of the coating applied to the curtain 14 can be about 27 grams per square meter (g/m²) or less.

The weave patterns used to weave the front and rear panels 40 and 42 are also selected to promote processing the woven roll 150 of material. The roll 150 is woven on a suitable loom, such as a Dobby or Jacquard loom. While the roll 150 is woven on the loom, the roll is tensioned in the warp direction. This tension is maintained while the yarn is woven on the loom and wound onto a beam (not shown).

Tension in the warp direction of the roll 150 is also maintained throughout subsequent processing operations, such as drying and coating operations (e.g., application and curing). In these operations, for example, the roll 150 may be unwound from one beam, fed through a processing device, such as a heater or coating machine, and wound onto another beam. Tensioning the roll 150 in the warp direction helps prevent the roll from shrinking in the warp direction during processing.

Tension on the roll 150 is not necessarily maintained in the fill direction during processing. Therefore, the roll 150 could be susceptible to shrinkage in the fill direction. For a given type of yarn, non-plain woven materials tend to shrink to a greater extent than plain woven materials. This is because the yarns of the plain woven materials are woven more tightly than yarns of non-plain woven materials. The yarns of the non-plain woven materials have more room for shifting and thus are able to shrink to a greater extent than the yarns of the plain woven material.

Since non-plain woven materials tend to shrink to a greater extent than plain woven materials, materials having plain woven portions and non-plain woven portions may undergo different degrees of shrinkage in different areas of the material. Depending on the relative locations of the plain and non-plain woven portions of the material, this differential shrinkage may result in creases, wrinkles, or puckering in the material. For an inflatable vehicle occupant protection device 14, such as the air bag 30, this may affect processing of the roll 150 because the creases, wrinkles, and puckering can make it difficult to apply a coating. This may also affect the packaging of the protection device 14 because the creases, wrinkles, and puckering can make it difficult to roll, fold, or otherwise place the protection device 14 in the stored condition.

According to the present invention, the weave pattern of the roll 150, and thus the front and rear panels 40 and 42 of the air bag 30 are constructed to avoid differential shrinkage and the problems described above. Referring to FIGS. 3A and 3C, in the fill direction of the roll 150, the 1×2 non-plain woven portions 176 have the same weave pattern as the plain woven portions 174. More particularly, in the non-plain woven portions 176, the fill yarns 172 are woven around the warp yarns 170 at every intersection with the warp yarns. Since the plain woven portions 174 and non-plain woven portions 176 have the same construction in the fill direction, shrinkage of the roll 150 in the fill direction will be generally uniform across the plain woven and non-plain woven portions. The weave pattern used to construct the roll 150 avoids differential shrinkage in the roll and thus avoids the creasing, wrinkling, and puckering described above. This helps promote processing of the roll 150 and packaging of the air bags 30.

In the illustrated embodiment, the non-plain weave pattern that helps provide these results is a 1×2 weave pattern. Alternative non-plain weave patterns may also be used to help achieve these results. For example, a 1×3-weave pattern includes fill yarns that are woven around warp yarns at every intersection and could thus be used to achieve these results. As another example, a weave repeat including all “1×” weave patterns could be used. An example of such a weave pattern repeat is a 1×2, 1×1, 1×1 repeat. In such a repeat, each 1×2 weave is followed by two 1×1 repeats.

Those skilled in the art will appreciate that the inclusion of the plain woven portions 174 and non-plain woven portions 176 in the weave pattern of the roll 150 may introduce some floats that unavoidably occur at the interface between the plain and non-plain woven portions. Some of these floats may occur in the fill direction of the roll 150. Examples of such unavoidable floats are indicated at 178 in the weave diagram 180 of FIG. 3A. These floats 178, being limited to the interface between the plain and non-plain woven portions 174 and 176 of the roll 150, form an extremely small portion of the width of the roll 150 (measured in the fill direction). For example, in a construction having twenty-five (25) yarns per centimeter (cm), the unavoidable floats 178 at the transition between the plain woven portions 174 and non-plain woven portions 176 would occupy less than one millimeter (mm). Therefore, these unavoidable floats 178 have little, if any, effect on the uniform shrinkage properties in the fill direction of the roll 150 and are therefore negligible.

From the description set forth above, those skilled in the art will appreciate that the configuration of the roll 150 using the described weave pattern and thus the air bags 30 provides advantageous properties. The configuration of the roll 150 promotes seam integrity by ensuring that plain woven portions 174 of the panels 40 and 42 are stitched together to form the seams 46 of the air bags 30. The configuration of the roll 150 also allows for easier and more compact packaging of the air bags 30 by including non-plain woven portions 176 that are better suited for rolling, folding, or otherwise placing the air bags in the stored condition. Since the air bags 30 are coated to provide a desired degree of gas permeability, the inclusion of the non-plain woven portions 176 does not impact the permeability of the air bags. The configuration of the roll 150 also helps ensure that any shrinkage in the fill direction is substantially uniform along the length of the roll by implementing a constant or substantially constant weave pattern in the fill direction of the roll.

Once the roll 150 is produced and any coatings 190 are applied, the individual front and rear panels 40 and 42, and any vent holes 164, are cut out. This cutting may be performed by cutting machines (not shown) that use vision systems to help improve cutting accuracy. The vision systems search for markers on the fabric of the roll 150 that allow the system to determine whether cuts are being made at the proper locations. Typically, these markers comprise intersecting marker yarns woven into the fabric of the roll 150. The marker yarns have a color that is different from the rest of the fabric on the roll 150 and thus stand out visually.

To weave the intersecting marker yarns, a beam of warp yarn having the marker color is installed at one or more warp positions on the loom. To form the marker yarn intersection, a yarn is inserted at the appropriate fill location along the length of the roll 150. The fill marker yarn requires a loom that has the capability of multiple fill yarn insertions, which can add cost to the manufacture of the roll 150. The warp marker yarn has no substantial impact on manufacturing costs.

According to the present invention, the roll 150 is woven with warp marker yarns only, eliminating the need for a fill marker yarn and any added costs associated therewith. Instead of weaving an intersection at the desired marker locations using a fill marker yarn, the weave pattern of the roll is adjusted so that the length of the marker yarn is increases at the marker locations. The length of the marker yarn at the marker locations is increased to a degree sufficient to be ascertained by the vision system of the cutting machine. This is done by weaving floats to the roll 150 with the marker yarn at the marker locations, an example of which is shown in FIG. 2.

In FIG. 2, the roll 150 includes two marker yarns indicated generally by the dashed lines at 192. In this example, the marker yarns 192 are woven in the warp direction along the length of the roll 150. The weave pattern of the marker yarns 192 follows the weave pattern of the particular portion of the roll 150 through which the marker yarn extends. In the plain woven portions 174 of the roll 150, the marker yarns 192 are woven in the plain weave pattern. In the non-plain woven portions 176 of the roll 150, the marker yarns 192 are woven in the non-plain weave pattern.

In FIG. 2, marker locations are shown at 194. At the marker locations 194, the weave pattern of the marker yarns 192 departs from the weave pattern of the surrounding portions of the roll 150. In the example of FIG. 2, the marker locations 194 are at the centers of the front and rear panels 40 and 42, respectively, and thus depart from the plain weave at the centers of the panels.

FIG. 4 illustrates the weave pattern of a marker yarn 192 in the area of one of the marker locations 194. As shown in FIG. 4, the marker yarn 192 is woven in the warp direction of the roll 150 in a plain woven portion 174 of the roll. At the marker location 194, the marker yarn 192 includes a float in the plain weave pattern 174 that results in the marker yarn being “up” at three adjacent intersections, which forms a marker 196 at the marker location. The vision system can detect the marker 196 and uses the marker to ensure that the roll 150 is cut in the desired locations to form the panels 40 and 42. Depending on the resolution of the vision system, the marker 196 may include more than three adjacent intersections where the marker yarn 192 is “up.”

Referring to FIG. 5, the inflatable curtain 80 also has a construction that promotes seam integrity, easier and more compact packaging, and uniform shrinkage in the fill direction. To accomplish this, in the one piece woven construction of the inflatable curtain 80, the panels 90 are woven with various different weave patterns. Portions 200 of the inflatable curtain 80 (indicated without cross-hatching) identify portions of the woven panels 90 that are woven in separate layers with a 1×1 plain weave. Portions 202 (cross-hatched) of the inflatable curtain 80 identify portions of the woven panels 90 that are woven in separate layers with a 1×2 basket weave. Portions 204 of the inflatable curtain 80 (cross-hatched) identify portions of the woven panels 90 that are woven together with a 3×3 basket weave to form the seams 92 of the curtain 80. The portion 204 forming the seams 92 may have an alternative weave pattern, such as a different basket weave pattern or weave repeat pattern.

The plain woven portions 200 include a portion 210 that extends around the entire periphery 212 of the inflatable curtain 80. This plain woven construction provides the peripheral edges of the inflatable curtain 80 with good edge-combing properties. The 1×2 basket woven portions 202 cover a substantial portion of the length of the inflatable curtain 80 and thus help provide the curtain with good packaging properties. The inflatable curtain 80 may include a coating 208 that covers the panels and helps provide a desired gas permeability of the curtain.

The 1×2 basket woven portions 202 are arranged such that the fill yarns are woven around the warp yarns at every intersection of the yarns. Therefore, the plain woven portions 200 and the 1×2 basket woven portions 202 have the same construction in the fill direction. As a result, shrinkage of the inflatable curtain 80 in the fill direction will be generally uniform along the length of the curtain. The weave pattern used to construct the inflatable curtain 80 avoids differential shrinkage in the panel and thus avoids the creasing, wrinkling, and puckering described above. This helps promote processing and packaging of the inflatable curtain 80.

In the embodiment of FIG. 5, alternative weave patterns may be used in place of the 1×2 basket woven portions 202. Examples of these alternative weave patterns include a 1×3 weave pattern or a weave repeat, such as a 1×2, 1×1, 1×1 repeat.

Those skilled in the art will appreciate that unavoidable floats may occur at the interface between the plain woven portions 200 and the 1×2 basket woven portions 202. Also, unavoidable floats may occur at the interface between the 3×3 basket woven portions 204 (i.e., the seams 92) and the plain woven portions 200. Further, unavoidable floats may occur at interfaces between the woven portions 200, 202 and 204 that are curved or extend at an angle with the warp and fill directions of the inflatable curtain 80. Some of these floats may occur in the fill direction of the inflatable curtain 80.

As described above, these floats, being limited to the interfaces between the woven portions 200, 202, and 204, form an extremely small portion of the width of the inflatable curtain 80 (measured in the fill direction). For example, in a construction having twenty-five (25) yarns per centimeter (cm), five floats would occupy only two millimeters (mm). Therefore, these unavoidable floats may have little, if any, effect on the uniform shrinkage properties in the fill direction of the inflatable curtain 80 and are therefore negligible.

The 3×3 basket woven portions 204 forming the seams 92 also form portions of the inflatable curtain 80 where groups of three fill yarns are woven around groups of three warp yarns, thus forming portions that are non-plain woven in the fill direction. Since, however, the layers 90 of material are woven together at the 3×3 basket woven portions 204, the weave is very tight as compared to 3×3 basket woven portions (not shown) woven in a dual layer portion of the inflatable curtain 80. In fact, depending on factors, such as yarn denier and weave density, the 3×3 basket weave may be the tightest weave obtainable for the single layer seams 92. Thus, it will be appreciated that the seams 92, having a non-plain woven construction in the fill direction, may nevertheless be so tightly woven that differential shrinkage of the inflatable curtain 80 in the fill direction does not occur.

From the description set forth above, those skilled in the art will appreciate that the configuration of the roll 150 using the described weave pattern and thus the air bags 30 provides advantageous properties. The configuration of the roll 150 promotes seam integrity by ensuring that plain woven portions 174 of the panels 40 and 42 are stitched together to form the seams 46 of the air bags 30. The configuration of the roll 150 also allows for easier and more compact packaging of the air bags 30 by including non-plain woven portions 176 that are better suited for rolling, folding, or otherwise placing the air bags in the stored condition. Since the air bags 30 are coated to provide a desired degree of gas permeability, the inclusion of the non-plain woven portions 176 does not impact the permeability of the air bags. The configuration of the roll 150 also helps ensure that any shrinkage in the fill direction is substantially uniform along the length of the roll by implementing a constant or substantially constant weave pattern in the fill direction of the roll.

Referring to FIG. 5, the inflatable curtain 80 includes panels 90 that are arranged in an overlying manner and interconnected to form seams 92 that help define an inflatable volume 94 of the inflatable curtain 80. The seams 92 may also help define inflatable chambers 96 within the inflatable volume 94 and non-inflatable portions 98 of the inflatable curtain 80. The inflatable curtain 80 may have a one piece woven construction in which the panels 90 of the curtain are woven simultaneously as separate single layers of material. At the seams 92, where the panels 90 are interconnected, the panels are woven together in a single layer.

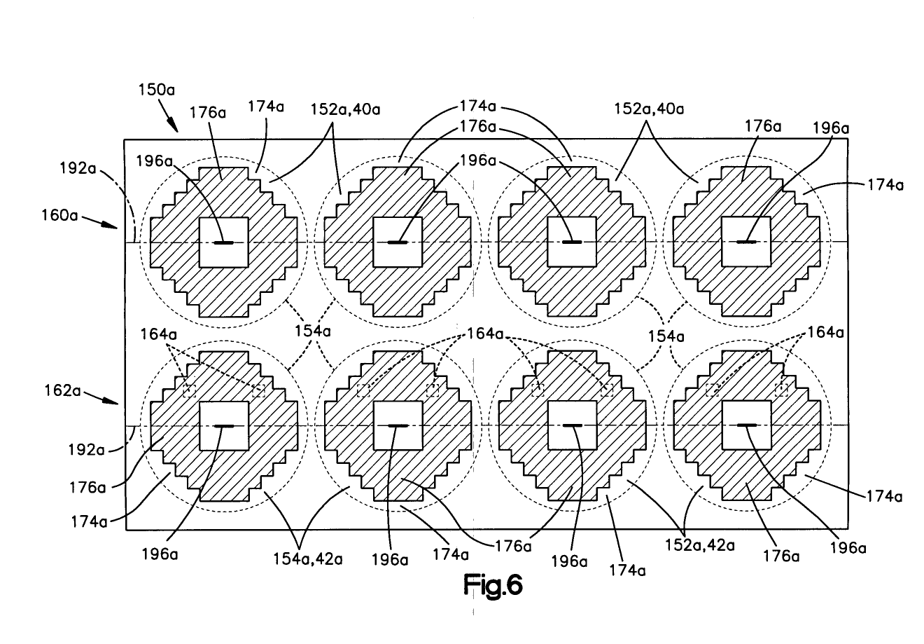

A second embodiment of the present invention is illustrated in FIG. 6. The second embodiment of the invention is similar to the first embodiment of the invention illustrated in FIGS. 1-4. Accordingly, numerals similar to those of FIGS. 1-4 will be utilized in FIG. 6 to identify similar components, the suffix letter “a” being associated with the numerals of FIG. 6 to avoid confusion.

Referring to FIG. 6, multiple woven panels 152a are formed in a single woven roll 150a of material. The roll 150a includes eight (8) panels 152a delineated by imaginary cut lines 154a. The panels 152a, when cut from the roll 150a, form the front and rear panels 40 and 42 (FIG. 1) that are interconnected to form the front impact air bag 30. A first row 160a (FIG. 5) of panels 152a form the front panels. A second row 162a of panels 152a form the rear panels. The panels 152a in the second row 162a may include openings 164a. The roll 150a may also includes marker yarns 192a that define markers 196a in the manner described above.

The roll 150a of the second embodiment and the roll 150 (FIG. 2) of the first embodiment have plain woven portions and non-plain woven portion with configurations that differ from each other. In the second embodiment of FIG. 6, the area of the panels 152a covered by the non-plain woven portion 176a is expanded. This helps improve the packaging properties of the air bags formed with the panels 152a in the manner described above. Also, the plain woven portions 174a are configured to be positioned around the peripheries and at the centers of the panels 152a, where stitching may occur. This helps improve the seam integrity (strength and edge combing) of the air bags formed with the panels 152a.

In the rolls 150 and 150a of the first and second embodiments, the plain woven portions 174 and 174a and non-plain woven portions 176 and 176a are defined by boundaries that extend parallel to either the warp or fill directions of the rolls. The rolls 150 and 150a can thus be woven using either a Dobby loom or a Jacquard loom. This may be advantageous where Dobby woven materials provide a cost savings over Jacquard woven materials. If curved boundaries are desired, a Jacquard loom can be used.

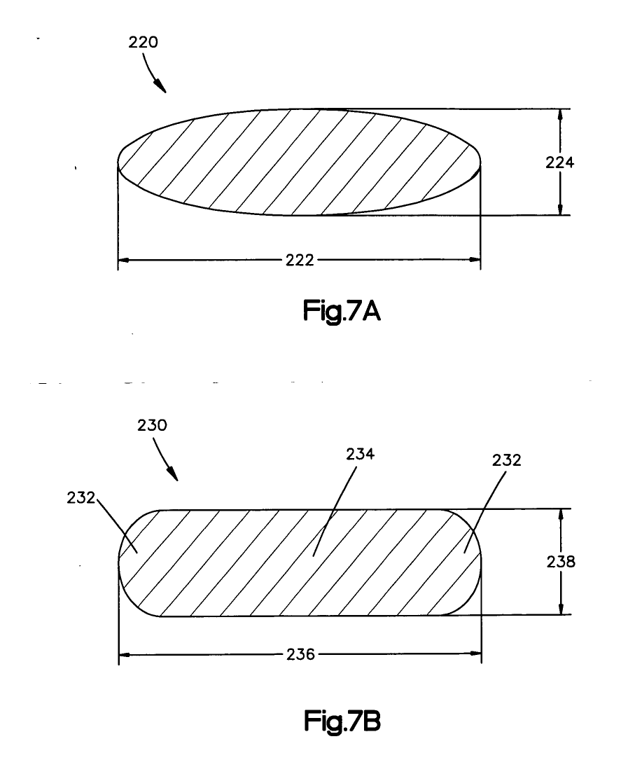

According to a third embodiment of the present invention, FIGS. 7A and 7B illustrate different yarns that may be used to construct the woven rolls described above in the embodiments of FIGS. 1-6. As shown in the sectional views of FIGS. 7A and 7B, the yarns each have a generally flat configuration and are referred to herein as “flat yarns.” As described below, the flat yarns help provide easier and more compact packaging of the protection devices without having a negative impact on seam integrity and processing.

Referring to FIG. 7A, a flat yarn 220 for use in weaving the protection devices has a generally elongated elliptical configuration with a major axis 222 and a minor axis 224. The flat yarn 220 may have any suitable denier, such as in the range of 350 to 470 dtex. For example, the flat yarn 220 may be a 410 dtex yarn.

Referring to FIG. 7B, a flat yarn 230 for use in weaving the protection devices has a generally elongated configuration with rounded end portions 232 and a generally rectangular or parallel walled central portion 234. The flat yarn 230 has a major axis 236 and a minor axis 238. Like the flat yarn of FIG. 7A, the flat yarn 230 may have any suitable denier, such as in the range of 350 to 470 dtex. For example, the flat yarn 230 may be a 410 dtex yarn.

The appearances of the flat yarns 220 and 230 in FIGS. 7A and 7B are illustrative of the general cross-sectional shape of the yarns. Instead of conventional round filaments used to construct conventional round yarns, the flat yarns 220 and 230 are constructed of filaments (not shown) that have a generally rectangular cross-section. These rectangular filaments are arranged to provide the cross-sections shown in FIGS. 7A and 7B. Because of this, it will be appreciated that the actual shape of the flat yarns 220 and 230 may vary to some extent from that shown in the figures, i.e., the flat yarns may not have a perfect oval or rounded rectangular shape.

The shape of the flat yarns 220 and 230 is somewhat defined by the flatness ratio of the yarns, i.e., the ratio of the major axis to the minor axis. For example, the flatness ratio of the flat yarns 220 and 230 may be in the range of 1.5:1 to 10:1 or more. In the embodiments illustrated in FIGS. 7A and 7B, the flat yarns 220 and 230 have a flatness ratio of about 3.75:1.

The flat yarns 220 and 230 may be used to weave the plain and non-plain woven portions of the protection devices. The flat yarns 220 and 230 may be woven in either or both the warp direction and the fill direction of the protection devices. To help improve the packaging of the protection devices, the flat yarns 220 and 230 are oriented with their respective major axes 222 and 236 extending parallel to the plane of the woven rolls used to construct the protection devices. Because the flat yarns 220 and 230 are relatively thin in the direction of their minor axes 222 and 236, they are readily bendable or foldable along fold lines extending horizontally as viewed in FIGS. 7A and 7B. As a result, the protection devices constructed with the flat yarns 220 and 230 can be readily rolled, folded, or otherwise placed in the deflated and stored condition. For example, in the embodiment of FIG. 5, the flat yarns can be woven in the fill direction to facilitate rolling the protection device about an axis parallel to its length.

From the above description of the invention, those skilled in the art will perceive improvements, changes and modifications. For example, in the illustrated embodiments, the air bag has a sewn seam construction and the inflatable curtain has a one-piece woven construction. As an alternative, the air bag could have a one-piece woven construction and the inflatable curtain could have a sewn construction. Such improvements, changes and modifications within the skill of the art are intended to be covered by the appended claims.

Having described the invention, the following is claimed:

1. An inflatable vehicle occupant protection device comprising:
overlying woven panels having portions interconnected to define an inflatable volume; and
a coating applied to at least one surface of each woven panel to control the gas permeability of the panels;
said woven panels each having at least one portion woven in a plain weave pattern and at least one portion woven in a non-plain weave pattern, the non-plain weave pattern being configured to improve the packaging properties of the protection device.

2. The inflatable vehicle occupant protection device recited in claim 1, wherein said woven panels are free from floats in the fill direction other than floats that occur at a transition between different weave patterns of the woven panels.

3. The inflatable vehicle occupant protection device recited in claim 2, wherein all of said floats in the fill direction are floats of no more than two yarns.

4. The inflatable vehicle occupant protection device recited in claim 1, wherein said non-plain weave pattern comprises a 1×2 weave pattern.

5. The inflatable vehicle occupant protection device recited in claim 1, wherein said non-plain weave pattern comprises a 1×3 weave pattern.

6. The inflatable vehicle occupant protection device recited in claim 1, wherein said non-plain weave pattern comprises a weave pattern repeat.

7. The inflatable vehicle occupant protection device recited in claim 1, wherein said woven panels are stitched together by stitching that extends through overlying portions of said woven panels that are woven with said plain weave pattern, said inflatable vehicle occupant protection device being free from stitching that extends through portions of said woven panels that are woven with said non-plain weave pattern.

8. The inflatable vehicle occupant protection device recited in claim 1, wherein said inflatable vehicle occupant protection device comprises a front impact air bag.

9. The inflatable vehicle occupant protection device recited in claim 1, wherein said panels are woven simultaneously, said panels being interconnected by weaving said panels together with a non-plain weave pattern.

10. The inflatable vehicle occupant protection device recited in claim 1, wherein said inflatable vehicle occupant protection device comprises a one piece woven inflatable curtain.

11. The inflatable vehicle occupant protection device recited in claim 1, wherein said non-plain woven portion extends along a substantial portion of a length of said inflatable vehicle occupant protection device.

12. The inflatable vehicle occupant protection device recited in claim 1, wherein said plain woven portion extends around an entire peripheral edge of said inflatable vehicle occupant protection device.

13. The inflatable vehicle occupant protection device recited in claim 1, further comprising at least one vent opening formed in at least one of said overlying woven panels.

14. The inflatable vehicle occupant protection device recited in claim 1, further comprising a tether stitched to a plain woven portion of at least one of said overlying woven panels.

15. The inflatable vehicle occupant protection device recited in claim 1, wherein said coating covers at least the portions of said panels that define said inflatable volume.

16. The inflatable vehicle occupant protection device recited in claim 1, further comprising at least one marker yarn in the form of a warp yarn of at least one of said panels, said at least one marker yarn being woven to include floats that define at least one marker location on said at least one panel.

17. The inflatable vehicle occupant protection device recited in claim 1, wherein the panels are at least partially woven using flat yarns.

18. The inflatable vehicle occupant protection device recited in claim 17, wherein the flat yarns have a flatness ratio of at least 1.5.

19. The inflatable vehicle occupant protection device recited in claim 17, wherein the flat yarns are 350-470 dtex yarns.

20. The inflatable vehicle occupant protection device recited in claim 17, wherein the flat yarns are 410 dtex yarns.

21. An inflatable vehicle occupant protection device comprising a roll of material woven to include at least one panel of the inflatable vehicle occupant protection device, said roll of material comprising at least one marker yarn in the form of a warp yarn of said roll of material, said at least one marker yarn being woven to include floats that define at least one marker location on said roll of material.

22. The inflatable vehicle occupant protection device recited in claim 21, wherein said at least one panel is to be cut out from said roll of material with a cutting machine, said marker locations being used by said cutting machine to help determine cut locations on said roll of material.

23. An inflatable vehicle occupant protection device comprising:
overlying woven panels interconnected to define an inflatable volume, said woven panels being woven with at least two different weave patterns, said weave patterns being configured to provide substantially uniform shrinkage in a fill direction of said panels along substantially the entire length of said panels measured perpendicular to said fill direction, said weave patterns also being configured to make said panels readily foldable to facilitate formation of a small package size of said inflatable vehicle occupant protection device.
